(19) United States
(12) Patent Application Publication
(10) Pub. No.: US 2009/0001918 A1
(43) Pub. Date: Jan. 1, 2009

(54) TRANSMISSION DEVICE

(75) Inventor: Johnson LIN, Taichung City (TW)

Correspondence Address: NIXON PEABODY, LLP, 401 9TH STREET, NW, SUITE 900, WASHINGTON, DC, 20004-2128, US

(73) Assignee: KAWATOMO TEC MODEL CO., LTD., Taichung City (TW)

(21) Appl. No.: 11/770,079

(22) Filed: Jun. 28, 2007

(51) Int. Cl. H02P 7/14

(52) U.S. Cl. 318/503

(57) ABSTRACT

A transmission device includes a power output unit and a non-contact type sensing unit. The power output unit includes a power output member that is rotatable about an axis, and has at least one sensed portion that is co-rotatable with the power output member about the axis. The non-contact type sensing unit detects the sensed portion and generates a sensor output from which angular displacement and position of the power output member can be calculated.

### BACKGROUND OF THE INVENTION

1. Field of the Invention

The invention relates to a transmission device, more particularly to a transmission device suitable for rotation speed control.

2. Description of the Related Art

Referring to FIGS. 1 and 2, a conventional transmission device 1 is shown to include a gear set 11, a servo motor 12, a controller 13, a potentiometer 14, and an analog-to-digital (AID) converter 15. The gear set 11 includes a driving gear 111, a driven gear 112, and a plurality of transmission gears 113 meshing with the driving gear 11 and the driven gear 112 for power transmission. The servo motor 12 is used to drive the driving gear 111. The controller 13 is programmable to control rotation speed of the servo motor 12. The potentiometer 14 is coupled coaxially to the driven gear 112, and is used to provide an analog feedback voltage. The A/D converter 15 is connected electrically to the potentiometer 14 and the controller 13 for converting the analog feedback voltage into a digital feedback signal that is provided to the controller 13.

When the servo motor 12 drives rotation of the driving gear 111, power is transmitted to the driven gear 112 through the transmission gears 113 and is outputted through rotation of the driven gear 112. Angular displacement of the driven gear 112 alters the resistance of the potentiometer 14 and results in a change in the analog feedback voltage. The A/D converter 15 generates the digital feedback signal from the analog feedback voltage and provides the digital feedback signal to the controller 13. Based on the digital feedback signal, the controller 13 calculates the angular displacement and position of the driven gear 112, and is thus able to control the servo motor 12 for correcting the angular position of the driven gear 112 to meet requirements.

However, due to constant contact between a wiper and a resistance element, wear of the potentiometer 14 is inevitable. Moreover, ambient factors, such as temperature fluctuations, dust, etc., can affect the resistance change of the potentiometer 14. The potentiometer 14 is thus not suitable for precision servo control applications. In addition, the transmission device 1 requires the A/D converter 15 for feedback signal conversion, which results in higher costs

### SUMMARY OF THE INVENTION

Therefore, the main object of the present invention is to provide a transmission device that is suitable for high precision applications.

Another object of the present invention is to provide a transmission device that has a relatively simple construction and that can be fabricated at a relatively low cost.

According to the present invention, a transmission device comprises a power output unit and a non-contact type sensing unit. The power output unit includes a power output member that is rotatable about an axis, and has at least one sensed portion that is co-rotatable with the power output member about the axis. The non-contact type sensing unit detects said at least one sensed portion and generates a sensor output from which angular displacement and position of the power output member can be calculated.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional transmission device;

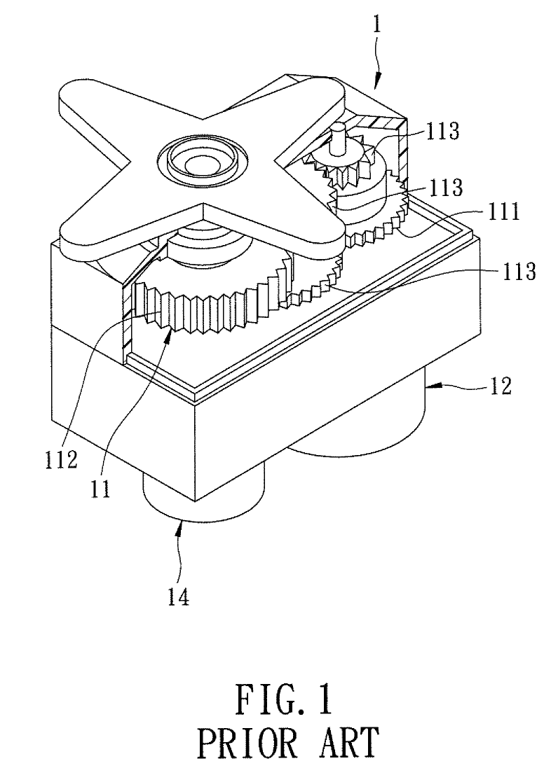

FIG. 2 is a block diagram of the conventional transmission device;

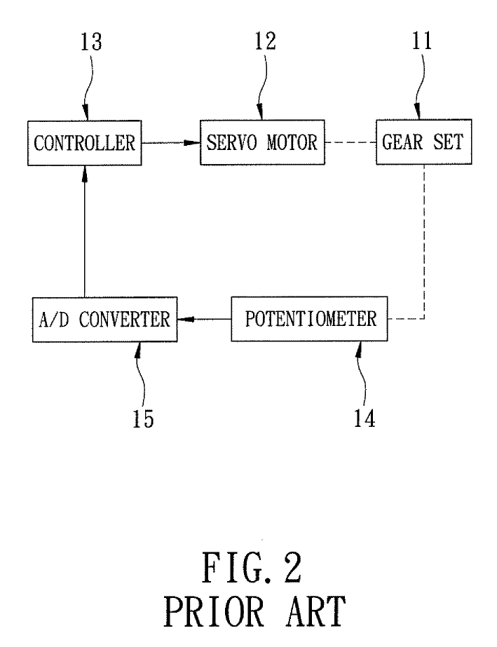

FIG. 3 is a perspective view of the first preferred embodiment of a transmission device according to the present invention;

FIG. 4 is a block diagram of the first preferred embodiment;

FIG. 5 is a perspective view of the second preferred embodiment of a transmission device according to the present invention;

FIG. 6 is a block diagram of the second preferred embodiment; and

FIG. 7 is a sectional view of the third preferred embodiment of a transmission device according to the present invention.

### DETAILED DESCRIPTION OF THE PREFERRED EMBODIMENTS

Before the present invention is described in greater detail with reference to the accompanying preferred embodiments, it should be noted here in that like elements are denoted by the same reference numerals throughout the disclosure.

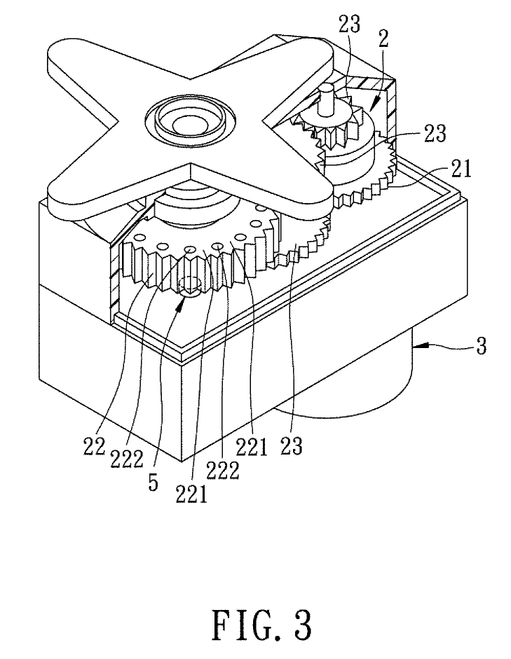

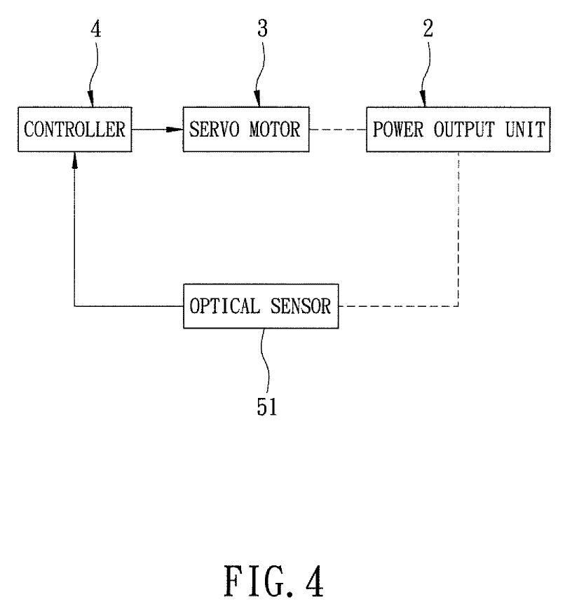

Referring to FIGS. 3 and 4, the first preferred embodiment of a transmission device according to the present invention is shown to include a power output unit 2, a servo motor 3, a programmable controller 4, and a non-contact type sensing unit 5.

The power output unit 2 includes a driving gear 21, a driven gear 22, and a plurality of transmission gears 23 meshing with the driving gear 21 and the driven gear 22 for power transmission. The driven gear 22 serves as a power output member in this embodiment, is rotatable about an axis, and is provided with a plurality of sensed portions 221 that are spaced apart radially from the axis and that are spaced apart angularly from each other, and a plurality of non-sensed portions 222, each of which is disposed between an adjacent pair of the sensed portions 221.

The servo motor 3 serves as a driving member in this embodiment, is coupled to the driving gear 21, and is used to drive rotation of the driving gear 21. The programmable controller 4 is connected to the servomotor 3 to control operation of the same.

The non-contact type sensing unit 5 is used to detect the sensed portions 221 and to generate a sensor output from which angular displacement and position of the driven gear 22 can be calculated. The non-contact type sensing unit 5 is connected to the programmable controller 4 and provides the sensor output to the programmable controller 4.

In this embodiment, the non-contact type sensing unit 5 includes an optical sensor 51 capable of transmitting and receiving light waves. The sensed portions 221 are parts of the driven gear 22 capable of reflecting the light waves transmitted by the optical sensor 51 back to the optical sensor 51, where as the non-sensed portions 222 are in the form of through holes having hole axes parallel to the axis.

When the servo motor 3 drives the driving gear 21 to rotate, power is transmitted to the driven gear 22 through the transmission gears 23, and is outputted through rotation of the driven gear 22. When the driven gear 22 rotates, light waves from the optical sensor 51 either pass through the non-sensed portions 222 or are reflected by the sensed portions 221 back to the optical sensor 51. The sensor output of the optical sensor 51 is thus in the form of a pulse train and is provided to the programmable controller 4. Based on the sensor output, the programmable controller 4 calculates the angular displacement and position of the driven gear 22, and is thus able to control the servo motor 3 for correcting the angular position of the driven gear 22 to meet requirements.

It is noted that, in other embodiments of this invention, the sensed and non-sensed portions 222, 221 may be provided on the driving gear 21 instead of the driven gear 22.

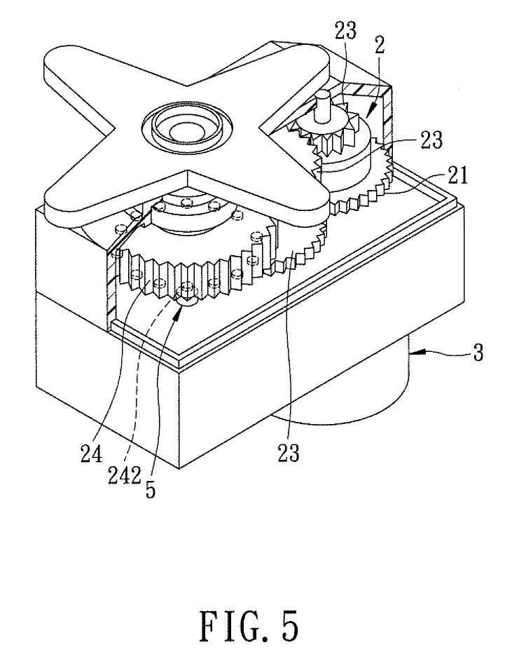

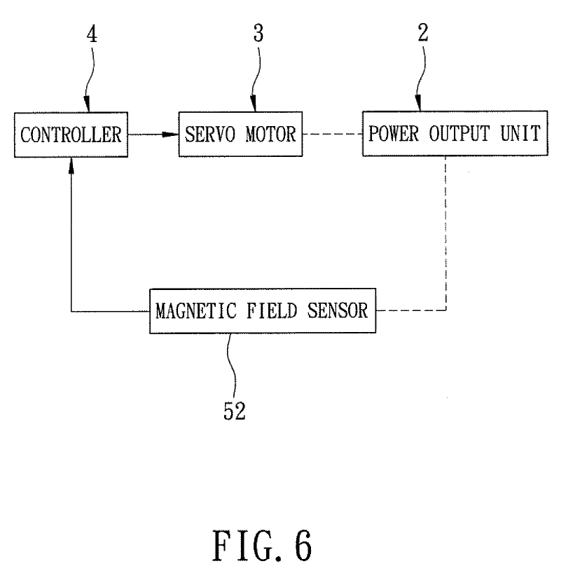

FIGS. 5 and 6 illustrate the transmission device according to the second preferred embodiment of the present invention. Unlike the first preferred embodiment, the non-contact type sensing unit 5 includes a magnetic field sensor S2, and the sensed portions 242 on the driven gear 24 are capable of generating a magnetic field to be detected by the magnetic field sensor. In this embodiment, each of the sensed portions 242 is provided with a magnet.

When the servo motor 3 drives the driving gear 21 to rotate, power is transmitted to the driven gear 24 through the transmission gears 23, and is outputted through rotation of the driven gear 24. When the driven gear 24 rotates, the magnetic field sensor 52 detects the sensed portions 242 intermittently. The sensor output of the optical sensor 51 is thus in the form of a pulse train and is provided to the programmable controller 4. Based on the sensor output, the programmable controller 4 calculates the angular displacement and position of the driven gear 24, and is thus able to control the servo motor 3 for correcting the angular position of the driven gear 24 to meet requirements.

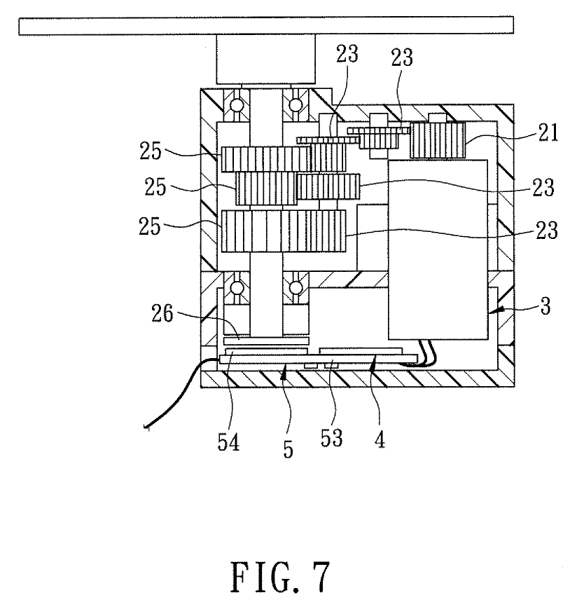

FIG. 7 illustrates the third preferred embodiment of the transmission device of the present invention. Unlike the previous embodiments, the non-contact type sensing unit 5 includes a hall sensor 54 mounted on a circuit board 53, and the sensed portion 26 of the power output unit 2 is an integrated magnetic concentrator rotatable co-axially with a set of the driven gears 25.

When the servo motor 3 drives the driving gear 21 to rotate, power is transmitted to the driven gears 25 through the transmission gears 23, and is outputted through rotation of the driven gears 25. When the driven gears 25 rotate, the hall sensor 54 detects a parallel magnetic flux component of the sensed portion 26, and accordingly generates a sensor output that is provided to the programmable controller 4. Based on the sensor output, the programmable controller 4 calculates the angular displacement and position of the driven gears 25, and is thus able to control the servo motor 3 for correcting the angular position of the driven gears 25 to meet requirements.

In sum, since the transmission device of this invention uses the noncontact type sensing unit 5 instead of a potentiometer, service life and precision of the transmission device can be enhanced as compared to the aforementioned prior art. Moreover, since there is no need for feedback signal conversion when the optical sensor 51, the magnetic field sensor 52 or the hall sensor 54 is utilized, the A/D converter required in the conventional transmission device can be eliminated to result in a simpler construction and lower manufacturing costs.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A transmission device comprising:
a power output unit including a power output member that is rotatable about an axis, and having at least one sensed portion that is co-rotatable with said power output member about the axis; and
a non-contact type sensing unit for detecting said at least one sensed portion and for generating a sensor output from which angular displacement and position of said power output member can be calculated.

2. The transmission device as claimed in claim 1, wherein said power output unit has a plurality of said sensed portions that are spaced apart radially from the axis and that are spaced apart angularly from each other.

3. The transmission device as claimed in claim 2, wherein said power output unit further has a plurality of non-sensed portions, each of which is disposed between an adjacent pair of said sensed portions and is co-rotatable with said power output member about the axis.

4. The transmission device as claimed in claim 3, wherein said power output member is provided with said sensed and non-sensed portions.

5. The transmission device as claimed in claim 1, wherein said non-contact type sensing unit includes an optical sensor capable of transmitting and receiving light waves.

6. The transmission device as claimed in claim 5, wherein said power output unit has a plurality of said sensed portions that are spaced apart radially from the axis, that are spaced apart angularly from each other, and that are capable of reflecting the light waves transmitted by said optical sensor back to said optical sensor.

7. The transmission device as claimed in claim 1, wherein said non-contact type sensing unit includes a magnetic field sensor.

8. The transmission device as claimed in claim 7, wherein said power output unit has a plurality of said sensed portions that are spaced apart radially from the axis, that are spaced apart angularly from each other, and that are capable of generating a magnetic field to be detected by said magnetic field sensor.

9. The transmission device as claimed in claim 8, wherein each of said sensed portions is provided with a magnet.

10. The transmission device as claimed in claim 1, wherein said non-contact type sensing unit includes a hall sensor.

11. The transmission device as claimed in claim 10, wherein said sensed portion of said power output unit is an integrated magnetic concentrator, and said hall sensor detects a magnetic flux component during rotation of said sensed portion about the axis.

12. The transmission device as claimed in claim 1, further comprising a driving member coupled to said power output unit for driving rotation of said power output member, and a programmable controller connected to said driving member for controlling operation of said driving member and further connected to said non-contact type sensing unit for receiving the sensor output therefrom.

13. The transmission device as claimed in claim 12, wherein said driving member includes a servo motor.

14. The transmission device as claimed in claim 1 wherein the sensor output is in a form of a pulse train.

15. The transmission device as claimed in claim 1, wherein said power output member is a gear.

16. The transmission device as claimed in claim 1, wherein said power output member is provided with said at least one sensed portion.
